(19) United States
(12) Patent Application Publication
(10) Pub. No.: US 2017/0124412 A1
(43) Pub. Date: May 4, 2017

(54) METHOD, APPARATUS, AND COMPUTER-READABLE MEDIUM FOR AREA RECOGNITION

(71) Applicant: Xiaomi Inc., Beijing (CN)

(72) Inventors: Fei LONG, Beijing (CN); Tao ZHANG, Beijing (CN); Zhijun CHEN, Beijing (CN)

(73) Assignee: Xiaomi Inc.

(21) Appl. No.: 15/299,671

(22) Filed: Oct. 21, 2016

(30) Foreign Application Priority Data
Oct. 30, 2015 (CN) 201510727934.X

(51) Int. Cl. G06K 9/32; G06K 9/46

(52) U.S. Cl. CPC G06K 9/325; G06K 9/4604; G06K 9/3283; G06K 9/3208; G06K 9/4647; G06K 9/4652

(57) ABSTRACT

A method for area recognition is disclosed. The method includes: recognizing an edge in an identification (ID) document image, the edge being in a predefined direction of the ID document; recognizing at least one information area in the ID document image based on the recognized edge; and cutting the information area to obtain at least one character area.

### CROSS-REFERENCE TO RELATED APPLICATION

This application is based upon and claims priority to Chinese Patent Application No. 201510727934.X, filed Oct. 30, 2015, the entire contents of which are incorporated herein by reference.

### FIELD

The present disclosure generally relates to image processing, and more particularly to method, apparatus, and computer-readable medium for area recognition.

### BACKGROUND

Automatic recognition of an identity (ID) card is a technology that recognizes characters on the ID card by image processing.

In the related art, a method for automatic recognition of an ID card comprises: scanning the ID card by a scanning device to obtain a scanned image of the ID card and recognizing characters at predefined areas in the scanned image to obtain information of at least one of a name, gender, nationality, date of birth, address, and ID number. However, it may still be difficult to recognize characters in an image of an ID card obtained by photographing.

### SUMMARY

According to a first aspect of the present disclosure, there is provided a method for area recognition, including: recognizing an edge in an identification (ID) document image, the edge being in a predefined direction of the ID document; recognizing at least one information area in the ID document image based on the recognized edge; and cutting the information area to obtain at least one character area.

According to another aspect of the present disclosure, there is provided an apparatus for area recognition, including a processor, and a memory configured to store instructions executable by the processor. The processor is configured to: recognize an edge in an identification (ID) document image, the edge being in a predefined direction of the ID document; recognize at least one information area in the ID document image based on the recognized edge; and cut the information area to obtain at least one character area.

According to another aspect of the present disclosure, there is provided a non-transitory computer-readable storage medium having instructions stored thereon, the instructions, when executed by a processor of a device, cause the device to: recognize an edge in an identification (ID) document image, the edge being in a predefined direction of the ID document; recognize at least one information area in the ID document image based on the recognized edge; and cut the information area to obtain at least one character area.

It is to be understood that both the forgoing general description and the following detailed description are exemplary only, and are not restrictive of the present disclosure.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart illustrating a method for area recognition according to an exemplary embodiment.

FIG. 2A is a flow chart illustrating a method for area recognition according to another exemplary embodiment.

FIG. 2B is a schematic diagram illustrating a binarized ID document image according to an exemplary embodiment.

FIG. 2C is a schematic diagram illustrating a line detected in the ID document image according to an exemplary embodiment.

FIG. 3A is a flow chart illustrating a method for area recognition according to another exemplary embodiment.

FIG. 3B is a schematic diagram illustrating the ID document image after an area-connection process according to an exemplary embodiment.

FIG. 4 is a flow chart illustrating a method for area recognition according to another exemplary embodiment.

FIG. 5A is a flow chart illustrating a method for area recognition according to another exemplary embodiment.

FIG. 5B is a schematic diagram illustrating a first histogram of an information area in the horizontal direction according to an exemplary embodiment.

FIG. 5C is a schematic diagram illustrating a set of consecutive rows on a first histogram of an information area in the horizontal direction according to an exemplary embodiment.

FIG. 5D is a schematic diagram illustrating a second histogram of an information area in the vertical direction according to an exemplary embodiment.

FIG. 5E is a schematic diagram illustrating a set of consecutive column on a second histogram of an information area in the vertical direction according to an exemplary embodiment.

FIG. 6 is a block diagram of an apparatus for area recognition according to an exemplary embodiment.

FIG. 7 is a block diagram of a recognition module according to an exemplary embodiment.

FIG. 8 is a block diagram of an apparatus for area recognition according to another exemplary embodiment.

FIG. 9 is a block diagram of an apparatus for area recognition according to another exemplary embodiment.

FIG. 10 is a block diagram of a cutting module, according to an exemplary embodiment.

FIG. 11 is a block diagram of an apparatus for area recognition according to an exemplary embodiment.

### DETAILED DESCRIPTION

Reference will now be made in detail to exemplary embodiments, examples of which are illustrated in the accompanying drawings. The following description refers to the accompanying drawings in which same numbers in different drawings represent same or similar elements unless otherwise described. The implementations set forth in the following description of exemplary embodiments do not represent all implementations consistent with the invention. Instead, they are merely examples of apparatuses and methods consistent with aspects related to the invention as recited in the appended claims.

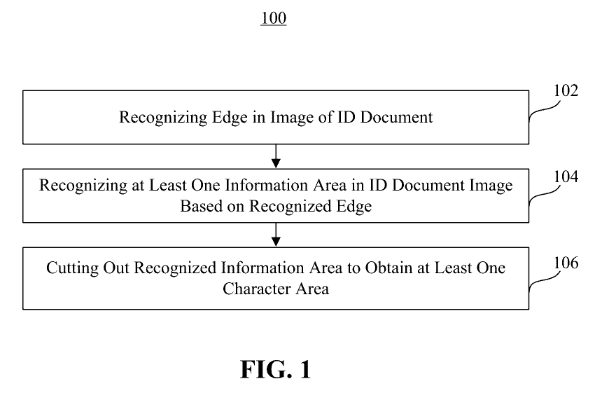

FIG. 1 is a flow chart illustrating a method 100 for area recognition according to an exemplary embodiment. The method 100 is performed by a processing device including one or more processors. As illustrated in FIG. 1, the method 100 may include the following steps.

In step 102, the processing device recognizes an edge in an image of an ID document. The edge is in a predefined direction of the ID document.

The ID document image is an image obtained by photographing the ID document. The ID document image may be an image of an ID card, a social security card, and the like.

The edge may be any one of upper edge, lower edge, left edge or right edge of the ID document.

In step 104, the processing device recognizes at least one information area in the ID document image based on the recognized edge.

A location of an edge in the ID document image is relatively predictable and generally easier to find than that of an information area so that respective information areas on the ID document can be determined from the ID document image based on the recognized edge.

An information area is an area having character information in the ID document image, such as an area showing name information, date of birth information, gender information, address information, ID number information, serial number information, issuance office of the ID document information, valid date information, and the like.

In step 106, the processing device cuts out the recognized information area to obtain at least one character area.

An information area may include a plurality of characters. At least one character area may be obtained by cutting the information area. A character area includes a single character. A character may be a Chinese character, an English letter, a number, or a character in other languages.

In the illustrated embodiment, the method 100 for area recognition includes recognizing an edge in an ID document image obtained by photographing; recognizing at least one information area in the ID document image based on the edge; and cutting the information area to obtain at least one character area. The method 100 overcomes the difficulty in the related art to recognize information areas in the ID document image obtained by photographing or inaccuracy in locating the information areas.

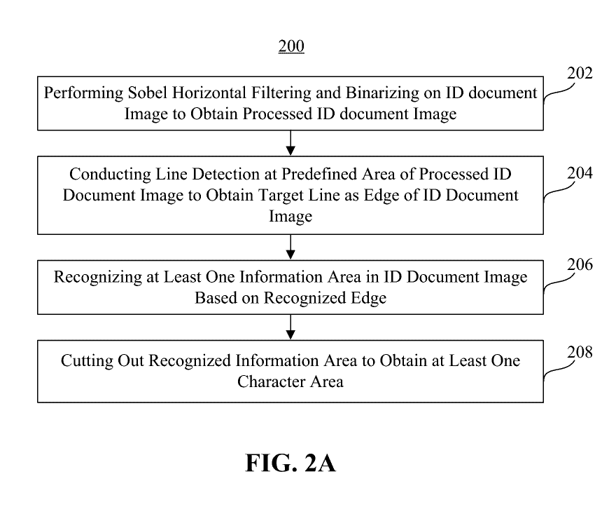

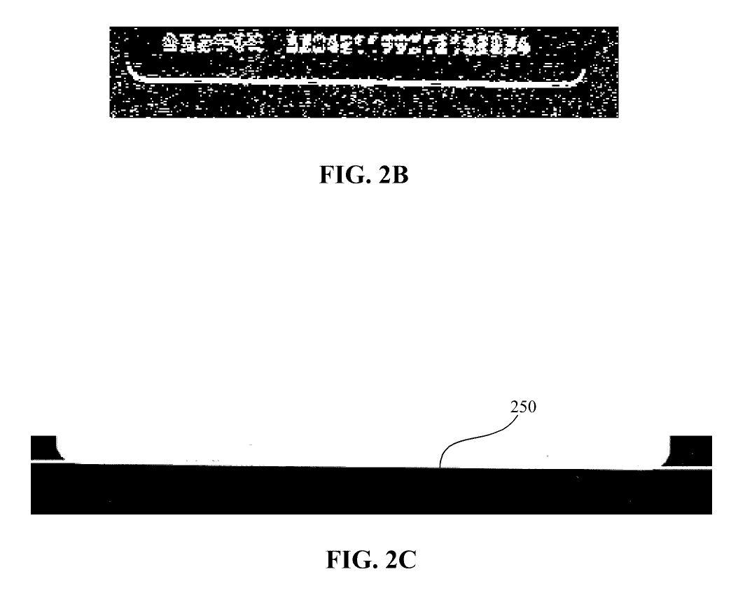

FIG. 2A is a flow chart illustrating a method 200 for area recognition according to another exemplary embodiment. The method 200 may be performed by a processing device including one or more processors. As illustrated in FIG. 2A, the method 200 for area recognition may include the following steps.

In step 202, the processing device performs Sobel horizontal filtering and binarizing on an ID document image to obtain a processed ID document image.

In one embodiment, when an ID document is photographed, a rectangular region in a photographing interface is provided for guiding the photographing. A user can photograph the ID document by aligning the rectangular region to the ID document so as to obtain the ID document image.

In the step 202, the ID document image is filtered horizontally by a Sobel operator. That is, the ID document image is filtered with a Sobel operator in the horizontal direction. The filtered ID document image is further binarized. In the binarizing process, gray-level values of the pixel points in the ID document image are compared with a predefined gray-level threshold to separate the pixel points in the ID document image into two groups: a first group of pixel points whose gray-level values are greater than the predefined gray-level threshold and a second group of pixel points whose gray-level values are less than the predefined gray-level threshold. The two groups of pixel points are presented with two different colors, such as black and white in the ID document image to generate the binarized ID document image. An example of a binarized ID document image is shown in FIG. 2B. The pixel points located in the foreground are referred to as the pixel points of foreground color, e.g., the white pixel points in FIG. 2B. The pixel points located in the background are referred to as the pixel points of background color, e.g., the black pixel points in FIG. 2B.

In step 204, the processing device conducts line detection at a predefined area of the processed ID document image to obtain a target line as an edge of the ID document image.

The predefined area is an area located in the ID document image where edges of the ID document may exist. For example, the predefined area is an area close to the lower edge of the ID document in the ID document image, or an area close to the upper edge of the ID document in the ID document image, and so on.

In the illustrated embodiment, the line detection is conducted on the processed ID document image. In one embodiment, the line detection may be realized by straight line fitting or Hough transformation, so as to obtain a target line. The target line is identified as an edge of the ID document image.

For example, after an ID document image is filtered by horizontal Sobel operator and binarized, line detection is conducted for the area close to the lower edge of the ID document in the ID document image. After straight line fitting or Hough transformation on the processed image, a line is generated below the ID document image. The line is identified as an edge of the ID document image. A lower edge portion of an ID document in the ID document image including a generated line 250 is shown in FIG. 2C.

In step 206, the processing device recognizes at least one information area in the ID document image based on the edge.

When the type of an ID document is known, relative locations between edges of the ID document image and information areas on the ID document can be known. At least one information area in the ID document image may be recognized based on the recognized edge and relative location relationship.

In one embodiment, the relative location relationship indicates relative locations between edges of the ID document image and information areas on the ID document.

In one embodiment, the ID document may be a second-generation Chinese ID card. The edge is the lower edge of the second-generation ID card, and the information area is a citizenship number area of the second-generation ID card. In the step 206, the area located in a predetermined distance above the lower edge is identified as the citizenship number area.

In a second-generation Chinese ID card, the citizenship number area is located above the lower edge of the ID document, and the address information area is located in the upper left from the lower edge of the ID document. At least one information area in the ID document image is recognized based on the edge.

In step 208, the processing device cuts out the recognized information area to obtain at least one character area.

An information area may include a plurality of characters. At least one character area may be obtained by cutting the information area. A character area includes a single character. A character may be a Chinese character, an English letter, a number, or a character in other languages.

In the illustrated embodiment, the method 200 for area recognition includes performing Sobel horizontal filtering and binarizing on the ID document image to obtain a processed ID document image; recognizing an edge in the processed ID document image; recognizing at least one information area in the ID document image based on the edge; and cutting the information area to obtain at least one character area. The method 200 overcomes the difficulty in the related art to recognize information areas in the ID document image obtained by photographing or inaccuracy in locating the information areas.

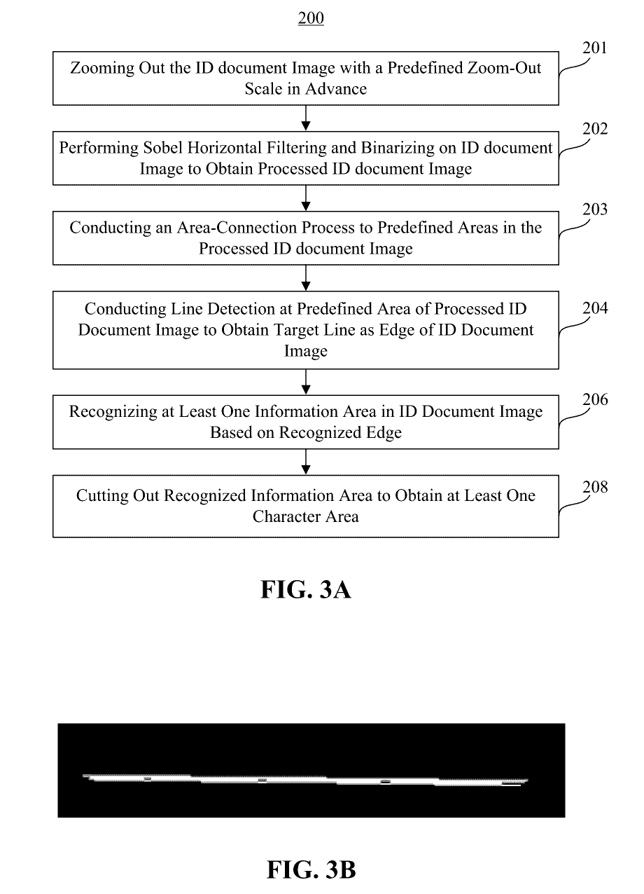

In some embodiments, in order to even more quickly recognize edges of an ID document, a processing device may zoom out the ID document image according to the size of the ID document image. In some embodiments, in order to even more accurately recognize a line on the processed ID document image, the processing device may conduct an area-connection process to predefined areas in the processed ID document image. FIG. 3A is a flow chart showing the method 200 further including steps 201 and 203. The step 201 is performed before step 202, and the step 203 is performed between steps 202 and 204, as illustrated in FIG. 3A.

In step 201, the processing device zooms out the ID document image with a predefined zoom-out scale.

The processing device may zoom out the ID document image with a predefined zoom-out scale according to the size of the ID document image to generate an ID document image having less blank areas around the ID document. The zoom-out processing may facilitate recognition of edges of the ID document image.

In step 203, the processing device conducts an area-connection process to predefined areas in the processed ID document image.

Upon acquiring an ID document image that is horizontally filtered by the Sobel operator and binarized, the processing device conducts an area-connection process to the processed ID document image, to remove one or more areas consisting of foreground pixel dots, e.g., white color pixel dots, in the binarized ID document image that do not form a line in a predefined direction, e.g., horizontal direction. For example, FIG. 3B illustrates an ID document image that is processed with area-connection process to remove areas consisting of white color pixel dots from the image shown in FIG. 2B, so that the predefined edge of the ID document image may be recognized even more accurately.

In the illustrated embodiment, the ID document image may be zoomed out with a predefined zoom-out scale, such that the predefined edges of the ID document image may be recognized even more quickly.

By an area-connection process on the processed ID document image, the accuracy of recognizing the predefined edges of the ID document image may be improved, to facilitate subsequent recognition of information areas.

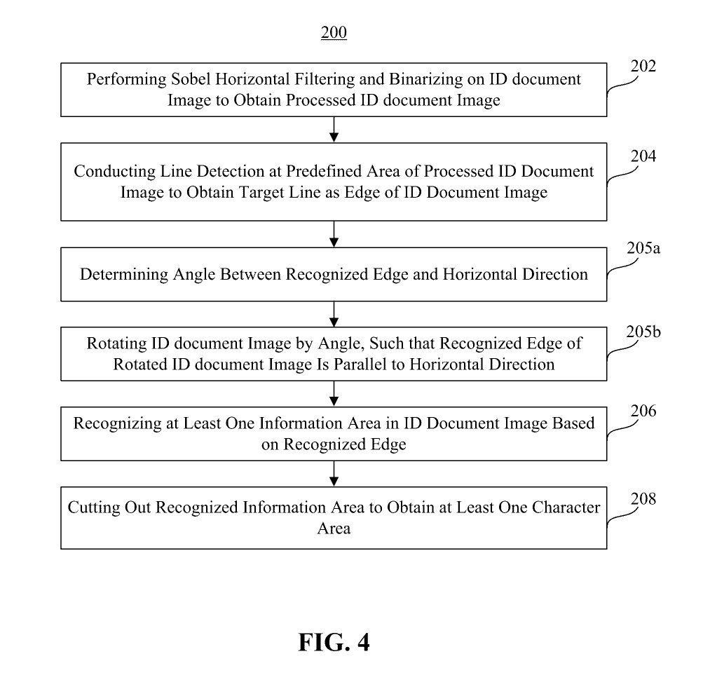

An ID document may be rotated from the horizontal or vertical direction when it is photographed in the ID document image. That is, edges of the ID document are not aligned with the horizontal or vertical direction of the ID document image. Instead, there is an angle between the horizontal direction and the ID document in the image. In some embodiments, the processing device conducts a tilt angle correction to the ID document image according to the slope of the predefined edge. FIG. 4 is a flow chart illustrating the method 200 as shown in FIG. 2A that further includes steps 205a and 205b. The steps 205a and 205b are performed after step 204.

In step 205a, an angle between the recognized edge, e.g., the lower edge (target line) of the ID document, and the horizontal direction is determined according to slope of the recognized edge. The processing device calculates an angle between the horizontal direction and the recognized edge of the ID document.

In step 205b, the ID document image is rotated by the angle, such that the recognized edge of the ID document is substantially parallel to the horizontal direction.

In the illustrated embodiment, the edge of the ID document in the ID document image is made to be substantially parallel to the horizontal direction by conducting a rotation correction to the recognized edge of the ID document image, to facilitate subsequent recognition of information areas.

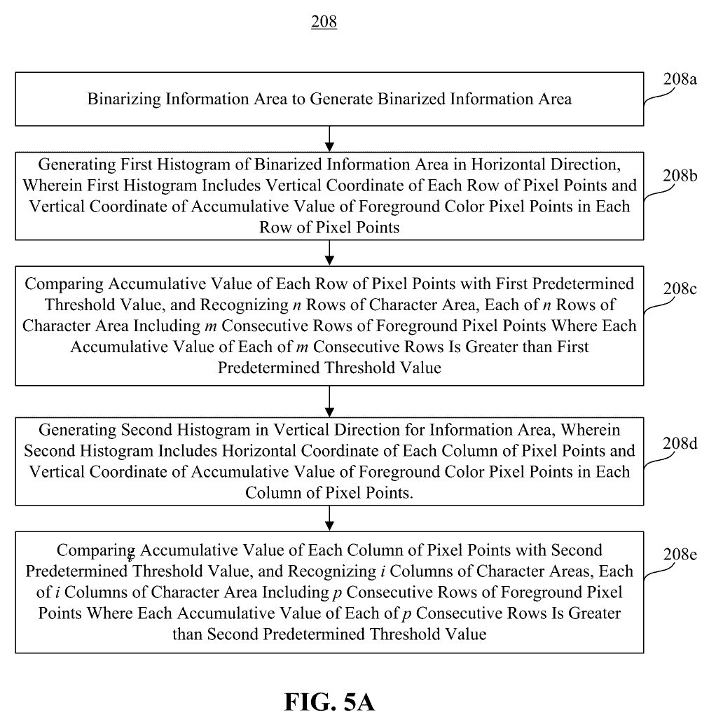

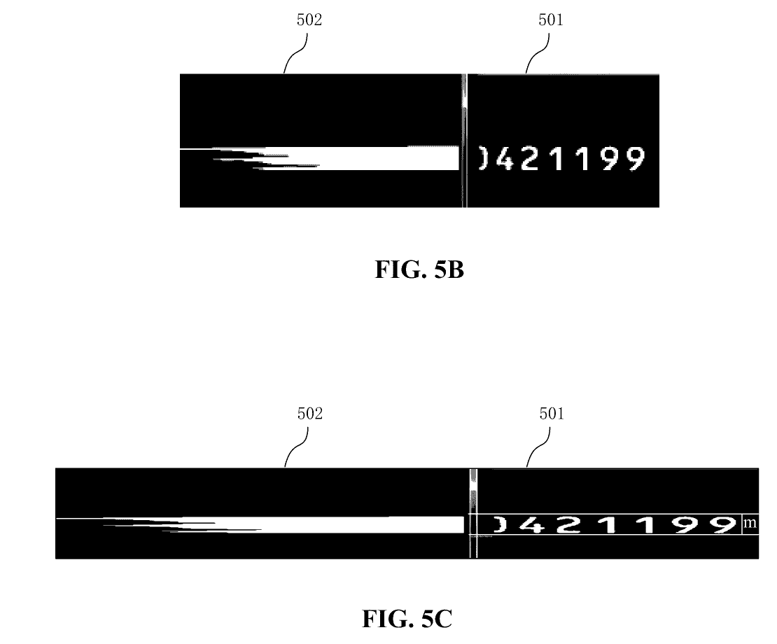

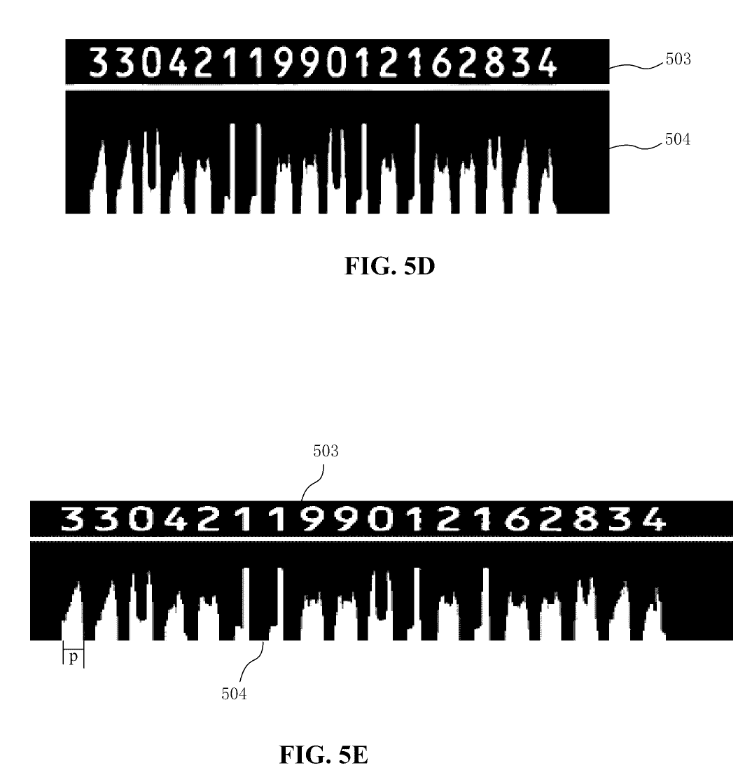

In some embodiments, the step 208 as shown in FIGS. 2A, 3A, and 4 may further include steps 208a-208e, as shown in FIG. 5A.

In step 208a, the recognized information area is binarized to obtain a binarized information area.

In some embodiments, the information area may be pre-processed before being binarized. For example, de-noising, filtering, extracting edges, and so on may be performed on the information area. The pre-processed information area is then binarized. In some embodiments, the step 208a may be omitted since the ID document is binarized from which the information area is recognized.

In step 208b, a first histogram of the binarized information area is generated in the horizontal direction. The first histogram includes a vertical coordinate of each row of pixel points and an accumulative value of a foreground color (e.g., white color) pixel points in each row of pixel points.

The first histogram of the binarized information area is generated based on accumulative pixel point values in the horizontal direction. For example, the total numbers of foreground color pixel points in one row can be added to form an accumulative value of that row. FIG. 5B illustrates an exemplary binarized information area 501 and a corresponding first histogram 502 of the binarized information area, where the vertical axis of the first histogram 502 represents the vertical location of each row of pixel points and the horizontal axis of the first histogram 502 represents accumulative values of foreground (white) color pixel points in each row.

In step 208c, the processing device compares the accumulative value of each row of pixel points with a first predetermined threshold value, and recognizes n rows of character areas. Each of the n rows of character areas includes m consecutive rows of foreground pixel points in the first histogram where each accumulative value of each of the m consecutive rows is greater than the first predetermined threshold value, wherein n and m are positive integers.

For example, the accumulative value of each row of pixel points can be acquired based on the first histogram. By comparing the accumulative value of each row of pixel points with the first predetermined threshold value, a set of consecutive rows can be recognized, where each accumulative value of each of the consecutive rows is greater than the first predetermined threshold value. The consecutive rows are recognized as a row of character areas where characters may be present in the information area.

For example, a set of m consecutive rows of pixel points shown in FIG. 5C is recognized as a row of character areas, where each accumulative value of each of the m consecutive rows of pixel points is greater than the first threshold. As shown in FIG. 5C, the m consecutive rows of pixel points correspond to a row of civil ID number “0421199” in the ID document image.

When the information area is an address information area or other information areas, the character areas may contain two or more rows of characters. Each set of consecutive rows of pixel points is recognized to be a row of character areas, and n sets of consecutive rows are recognized to be n rows of character areas.

Referring back to FIG. 5A, in step 208d, a second histogram is generated in the vertical direction for the information area. The second histogram includes a horizontal coordinate of each column of pixel points and an accumulative value of foreground color (e.g., white color) pixel points in each column of pixel points.

The second histogram of the binarized information area is generated based on accumulative pixel-point values in the vertical direction. For example, the total numbers of foreground color pixel points in one column can be added to form an accumulative value of that column. FIG. 5D illustrates an exemplary binarized information area 503 and a corresponding second histogram 504 of the binarized information area, where the horizontal axis of the second histogram 504 represents the horizontal location of each column of pixel points and the vertical axis of the second histogram 504 represents accumulative values of foreground (white) color pixel points in each column.

In step 208e, the processing device compares the accumulative value of each column of pixel points with a second predetermined threshold value, and recognizes i columns of character areas. Each of the i columns of character areas includes p consecutive columns of foreground pixel points in the second histogram where each accumulative value of each of the p consecutive columns is greater than the second predetermined threshold value, wherein i and p are positive integers.

For example, the accumulative value of each column of pixel points can be acquired based on the second histogram. By comparing the accumulative value of each column of pixel points with the second predetermined threshold value, a set of consecutive columns can be recognized, where each accumulative value of each of the consecutive columns is greater than the second predetermined threshold value. The consecutive columns are recognized as a column of character area where a character may be present in the information area.

For example, a set of p consecutive columns of pixel points shown in FIG. 5E is recognized as a column of a character area, where each accumulative value of each of the p consecutive columns of pixel points is greater than the second predetermined threshold value. As shown in FIG. 5E, the p consecutive columns of pixel points correspond to the character area “3” in the information area 503.

Each set of consecutive columns is recognized to be one character area and i sets of columns are identified to be i character areas. In FIG. 5E, 18 character areas can be recognized.

When there are n rows of character areas, the steps 208d and 208e are performed one time for each row of character areas, to recognize character areas.

For each recognized character area, a character contained in the character area can be recognized through character recognition technology. The characters may be Chinese characters, English letters, numbers, and characters of other languages.

In summary, the method 200 including the steps shown in FIG. 5A includes: binarizing the information area; generating a first histogram of the binarized information area in the horizontal direction; determining n rows of character areas in the information area; generating a second histogram of the i columns of character areas in the vertical direction; and recognizing the character areas corresponding to characters.

The present disclosure further provides apparatuses for performing the above-explained methods. Some details of the following apparatus, if not described herein, may be referred to the methods above.

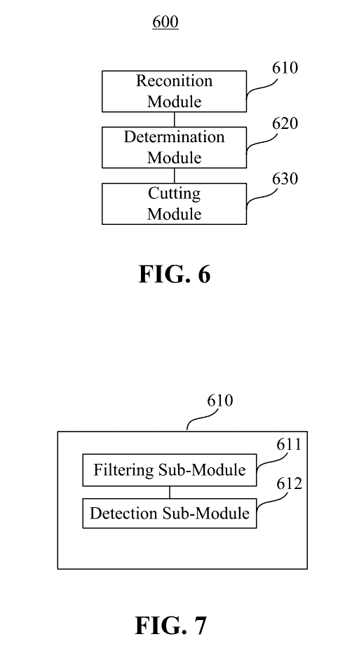

FIG. 6 is a block diagram of an apparatus 600 for area recognition according to an exemplary embodiment. As shown in FIG. 6, the apparatus 600 includes a recognition module 610, a determination module 620, and a cutting module 630.

The recognition module 610 is configured to recognize an edge in an image of an ID document. The edge is in a predefined direction of the ID document.

The ID document image is an image obtained by photographing the ID document. The ID document image may be an image of an ID card, a social security card, and the like.

The determination module 620 is configured to recognize at least one information area in the ID document image based on the recognized edge.

A location of an edge in the ID document image is relatively predictable and generally easier to find than that of an information area so that respective information areas on the ID document can be determined from the ID document image based on the recognized edge.

An information area is an area having character information in the ID document image, such as an area showing name information, date of birth information, gender information, address information, ID number information, serial number information, issuance office of the ID document information, valid date information, and the like.

The cutting module 630 is configured to cut out/divide the recognized information area to obtain at least one character area.

An information area may include a plurality of characters. At least one character area may be obtained by the cutting module 630. A character area includes a single character. A character may be a Chinese character, an English letter, a number, or a character in other languages.

In the illustrated embodiment, the apparatus 600 for area recognition includes the recognition module 610 configured to recognize an edge in an ID document image obtained by photographing; the determination module 620 configured to recognize at least one information area in the ID document image based on the edge; and the cutting module 630 configured to cut the information area to obtain at least one character area. The apparatus 600 overcomes the difficulty in the related art to recognize information areas in the ID document image obtained by photographing or inaccuracy in locating the information areas.

In some embodiments, referring to FIG. 7, the recognition module 610 may include a filtering sub-module 611 and a detection sub-module 612.

The filtering sub-module 611 is configured to perform Sobel horizontal filtering and binarizing on an ID document image to obtain a processed ID document image. That is, the ID document image is filtered with a Sobel operator in the horizontal direction. The filtered ID document image is binarized.

In the binarizing process, the filtering sub-module 611 is configured to compare gray-level values of the pixel points in the ID document image with a predefined gray-level threshold to separate the pixel points in the ID document image into two groups: a first group of pixel points whose gray-level values are greater than the predefined gray-level threshold and a second group of pixel points whose gray-level values are less than the predefined gray-level threshold. The two groups of pixel points are presented with two different colors, such as black and white in the ID document image to generate the binarized ID document image.

The detection sub-module 612 is configured to conduct line detection at a predefined area of the processed ID document image to obtain a target line as an edge of the ID document image.

The predefined area is an area located in the ID document image where edges of the ID document may exist. For example, the predefined area is an area close to the lower edge of the ID document in the ID document image, or an area close to the upper edge of the ID document in the ID document image, and so on.

Upon obtaining the ID document image processed by the filtering sub-module 611, the detection sub-module 612 conducts the line detection on the processed ID document image. In one embodiment, the line detection may be realized by straight line fitting or Hough transformation, so as to obtain a target line. The target line is identified as an edge of the ID document image.

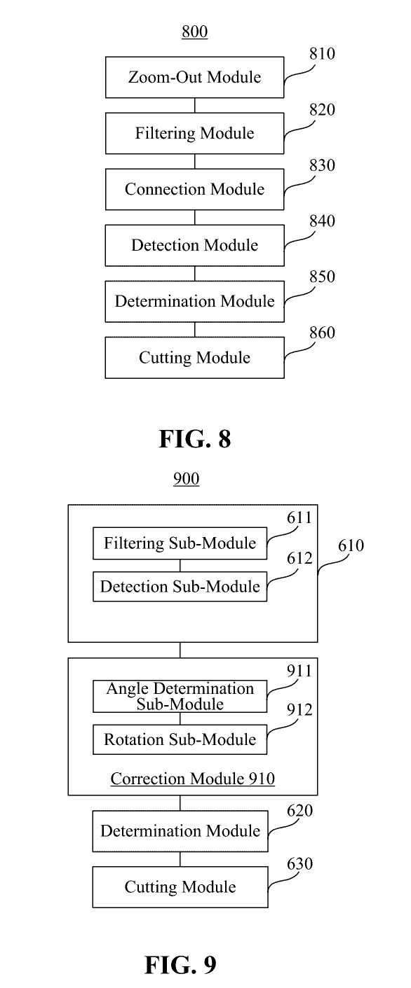

FIG. 8 is a block diagram of an apparatus 800 for area recognition according to another exemplary embodiment of the present disclosure. Referring to FIG. 8, the apparatus 800 includes a zoom-out module 810, a filtering module 820, a connection module 830, a detection module 840, a determination module 850, and a cutting module 860. The filtering module 820 and detection module 840 are similar to the filtering sub-module 611 and the detection sub-module 612 shown in FIG. 7, respectively, and the details of their functions and actions can be referred to the above descriptions. The determination module 850 and the cutting module 860 are similar to the determination module 620 and the cutting module 630 shown in FIG. 6, respectively, and their functions and actions can be referred to the above descriptions.

The zoom-out module 810 is configured to zoom out the ID document image with a predefined zoom-out scale.

The zoom-out module 810 zooms out the ID document image with a predefined zoom-out scale according to the size of the ID document image to generate an ID document image having less blank areas around the ID document. The zoom-out processing may facilitate recognition of edges of the ID document image.

The connection module 830 is configured to conduct an area-connection process to predefined areas in the processed ID document image.

Upon acquiring an ID document image processed by the filtering module 820, the connection module 830 conducts an area-connection process to the processed ID document image, to remove areas consisting of foreground pixel dots, e.g., white color pixel dots, in the binarized ID document image that do not form a line in a predefined direction, e.g., horizontal direction, so that the predefined edge of the ID document image may be recognized even more accurately.

In one embodiment, the ID document may be a second-generation Chinese ID card. The edge is the lower edge of the second generation ID card; and the information area is a citizenship number area of the second-generation ID card. The determination module 850 is further configured to recognize the area located in a predetermined distance above the lower edge as the citizenship number area.

In the illustrated embodiment, the apparatus 800 may zoom out the ID document image with a predefined zoom-out scale, such that the predefined edges of the ID document image may be recognized even more quickly.

By an area-connection process performed by the connection module 830 on the processed ID document image, the accuracy of recognizing the predefined edges of the ID document image may be improved, to facilitate subsequent recognition of information areas.

FIG. 9 is a block diagram of an apparatus 900 for recognizing areas according to another exemplary embodiment of the present disclosure. Referring to FIG. 9, the apparatus 900 includes a recognition module 610, a determination module 620, a cutting module 630, and a correction module 910. The recognition module 610, the determination module 620, and the cutting module 630 of the apparatus 900 are similar to the recognition module 610, the determination module 620, and the cutting module 630 shown in FIGS. 6 and 7, and the details of their functions and actions can be referred to the above descriptions and are not repeated herein.

The correction module 910 is configured to conduct a tilt angle correction to the ID document image according to a slope of the predefined edge.

In some embodiments, the correction module 910 may include an angle determination sub-module 911 and a rotation sub-module 912.

The angle determination module 911 is configured to determine an angle between the recognized edge, e.g., the lower edge (target line) of the ID document, and the horizontal direction according to the slope of the recognized edge.

The rotation sub-module 912 is configured to rotate the ID document image by the angle, such that the recognized edge of the rotated ID document is substantially parallel to the horizontal direction.

In the illustrated embodiment, the edge of the ID document in the ID document image is made to be substantially parallel to the horizontal direction by conducing rotation correction to the recognized edge of the ID document image, to facilitate subsequent recognition of information areas.

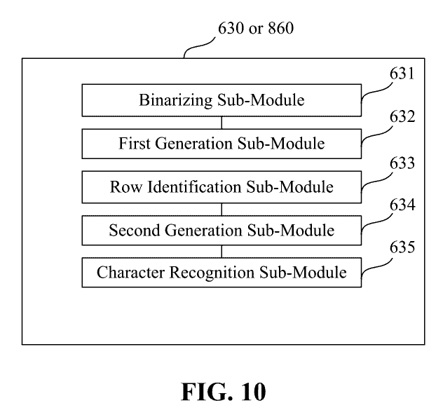

In some embodiments, the cutting module 630 as shown in FIGS. 6 and 9 or the cutting module 860 shown in FIG. 8 may include a binarizing sub-module 631, a first generation sub-module 632, a row recognition sub-module 633, a second generation sub-module 634, and a character recognition sub-module 635, as shown in FIG. 10.

The binarizing sub-module 631 is configured to binarize the information area to obtain a binarized information area.

In some embodiments, the information area may be pre-processed before being binarized. For example, de-noising, filtering, extracting edges, and so on may be performed on the information area. The pre-processed information area is then binarized.

The first generation sub-module 632 configured to generate a first histogram of the binarized information area in the horizontal direction. The first histogram includes a vertical coordinate of each row of pixel points and a horizontal coordinate indicating an accumulative value of the foreground color (e.g., white color) pixel points in each row of pixel points.

The first histogram of the binarized information area is generated based on accumulative pixel point values in horizontal direction. For example, the total numbers of foreground color pixel points in one row can be added to form an accumulative value of that row.

The row recognition sub-module 633 configured to compare the accumulative value of each row of pixel points with a first predetermined threshold value, and recognize n rows of character areas. Each of the n rows of character areas includes m consecutive rows of foreground pixel points in the first histogram where each accumulative value of each of the m consecutive rows is greater than the first predetermined threshold value, wherein n and m are positive integers

Each set of consecutive rows of pixel points is recognized to be a row of character areas and n sets of consecutive rows are recognized to be n rows of character areas.

The second generation sub-module 634 is configured to generate a second histogram in the vertical direction for the information area. The second histogram includes a horizontal coordinate of each column of pixel points and a vertical coordinate of an accumulative value of the foreground color (e.g., white color) pixel points in each column of pixel points.

The second histogram of the binarized information area is generated by the second generation sub-module 634 based on accumulative pixel-point values in the vertical direction. For example, the total numbers of foreground color pixel points in one column can be added to form an accumulative value of that column.

The character recognition sub-module 635 configured to compare the accumulative value of each column of pixel points with a second predetermined threshold value, and recognize i columns of character areas. Each of the i columns of character area includes p consecutive columns of foreground pixel points in the second histogram where each accumulative value of each of the p consecutive column is greater than the second predetermined threshold value, wherein i and p are positive integers.

For example, the accumulative value of each column of pixel points can be acquired based on the second histogram. By comparing the accumulative value of each column of pixel points with the second predetermined threshold value, a set of consecutive rows can be recognized, where each accumulative value of each of the consecutive columns is greater than the second predetermined threshold value. The consecutive columns of pixel points are recognized as a column of character areas where characters may be present in the information area.

Each set of consecutive columns is recognized to be one character area and i sets of consecutive columns are recognized to be i character areas.

An apparatus for recognizing areas is provided to implement the above methods. The apparatus comprises: a processor and a memory for storing processor-executable instructions, wherein the processor is configured to perform one or more steps in the above-explained methods.

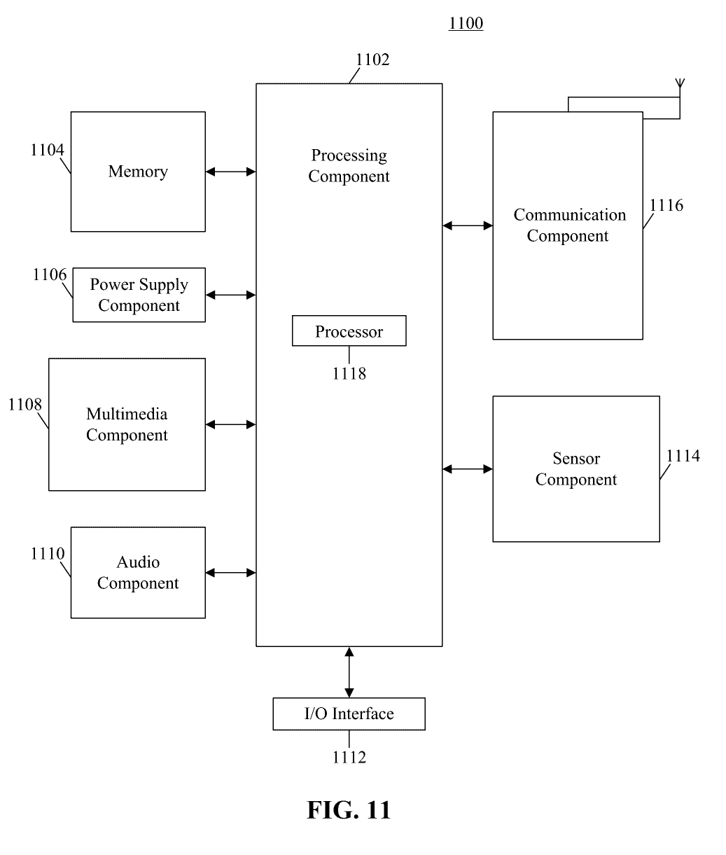

FIG. 11 is a block diagram illustrating an apparatus 1100 for recognizing areas according to an exemplary embodiment. The apparatus 1100 is configured to perform one or more steps in the methods described above.

For example, the apparatus 1100 may be a mobile phone, a computer, a digital broadcast terminal, a messaging device, a gaming console, a tablet, a medical device, exercise equipment, a personal digital assistant, and the like.

Referring to FIG. 11, the apparatus 1100 may comprise one or more of the following components: a processing component 1102, a memory 1104, a power supply component 1106, a multimedia component 1108, an audio component 1110, an input/output (I/O) interface 1112, a sensor component 1114, and a communication component 1116.

The processing component 1102 typically controls overall operations of the apparatus 1100, such as the operations associated with display, telephone calls, data communications, camera operations, and recording operations. The processing component 1102 may comprise one or more processors 1118 to execute instructions to perform all or part of the steps in the above described methods. Moreover, the processing component 1102 may comprise one or more modules which facilitate the interaction between the processing component 1102 and other components. For instance, the processing component 1102 may comprise a multimedia module to facilitate the interaction between the multimedia component 1108 and the processing component 1102.

The memory 1104 is configured to store various types of data to support the operation of the apparatus 1100. Examples of such data comprise instructions for any applications or methods operated on the apparatus 1100, contact data, phonebook data, messages, images, video, etc. The memory 1104 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power supply component 1106 provides power to various components of the apparatus 1100. The power component 1106 may comprise a power management system, one or more power sources, and any other components associated with the generation, management, and distribution of power for the apparatus 1100.

The multimedia component 1108 comprises a screen providing an output interface between the apparatus 1100 and the user. In some embodiments, the screen may comprise a liquid crystal display (LCD) and a touch panel (TP). If the screen comprises the touch panel, the screen may be implemented as a touch screen to receive input signals from the user. The touch panel comprises one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1108 comprises a front camera and/or a rear camera. The front camera and the rear camera may receive an external multimedia datum while the apparatus 1100 is in an operation mode, such as a photographing mode or a video mode. Each of the front camera and the rear camera may be a fixed optical lens system or capable of optical focusing and zooming.

The audio component 1110 is configured to output and/or input audio signals. For example, the audio component 1110 comprises a microphone (MIC) configured to receive an external audio signal when the apparatus 1100 is in an operation mode, such as a call mode, a recording mode, and a voice identification mode. The received audio signal may be further stored in the memory 1104 or transmitted via the communication component 1116. In some embodiments, the audio component 1110 further comprises a speaker to output audio signals.

The I/O interface 1112 provides an interface between the processing component 1102 and peripheral interface modules, the peripheral interface modules being, for example, a keyboard, a click wheel, buttons, and the like. The buttons may comprise, but are not limited to: a home button, a volume button, a starting button, and a locking button.

The sensor component 1114 comprises one or more sensors to provide status assessments of various aspects of the apparatus 1100. For instance, the sensor component 1114 may detect an open/closed status of the apparatus 1100, relative positioning of components (e.g., the display and the keypad of the apparatus 1100), a change in position of the apparatus 1100 or a component of the apparatus 1100, a presence or absence of user contact with the apparatus 1100, an orientation or an acceleration/deceleration of the apparatus 1100, and a change in temperature of the apparatus 1100. The sensor component 1114 may comprise a proximity sensor configured to detect the presence of a nearby object without any physical contact. The sensor component 1114 may also comprise a light sensor, such as a CMOS or CCD image sensor, for use in imaging applications. In some embodiments, the sensor component 1114 may also comprise an accelerometer sensor, a gyroscope sensor, a magnetic sensor, a pressure sensor, or a temperature sensor.

The communication component 1116 is configured to facilitate communication, wired or wirelessly, between the apparatus 1100 and other devices. The apparatus 1100 can access a wireless network based on a communication standard, such as WiFi, 2G, or 3G, or a combination thereof. In an exemplary embodiment, the communication component 1116 receives a broadcast signal or broadcast associated information from an external broadcast management system via a broadcast channel. In an exemplary embodiment, the communication component 1116 further comprises a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the apparatus 1100 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer readable storage medium including instructions, such as included in the memory 1104, executable by the processor 1118 in the apparatus 1100, for performing the above-described methods. For example, the non-transitory computer-readable storage medium may be a ROM, a RAM, a CD-ROM, a magnetic tape, a floppy disc, an optical data storage device, and the like.

It should be understood by those skilled in the art that the above described modules can each be implemented through hardware, or software, or a combination of hardware and software. One of ordinary skill in the art will also understand that multiple ones of the above described modules may be combined as one module, and each of the above described modules may be further divided into a plurality of sub-modules.

Other embodiments of the invention will be apparent to those skilled in the art from consideration of the specification and practice of the disclosures herein. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the invention being indicated by the following claims.

It will be appreciated that the inventive concept is not limited to the exact construction that has been described above and illustrated in the accompanying drawings, and that various modifications and changes can be made without departing from the scope thereof. It is intended that the scope of the disclosure to be limited by the appended claims only.

What is claimed is:

1. A method for area recognition, comprising:
recognizing an edge in an identification (ID) document image, the edge being in a predefined direction of the ID document;
recognizing at least one information area in the ID document image based on the recognized edge; and
cutting the information area to obtain at least one character area.

2. The method of claim 1, wherein the recognizing an edge in an ID document image comprises:
performing Sobel horizontal filtering and binarizing on the ID document image to obtain a processed ID document image; and
conducting a line detection for a predefined area in the processed ID document image to obtain a target line, wherein the target line is recognized as the edge of the ID document image.

3. The method of claim 2, further comprising:
zooming out the ID document image with a predefined zoom-out scale.

4. The method of claim 2, further comprising:
conducting an area-connection process to remove areas outside of the ID document in the processed ID document image.

5. The method of claim 1, wherein the recognizing at least one information area in the ID document image based on the recognized edge comprises:
recognizing the at least one information area based on the recognized edge and a relative location relationship between the recognized edge and the information area.

6. The method of claim 1, further comprising:
conducting a tilt angle correction to the ID document image to rotate the ID document image so that the recognized edge is substantially parallel to a horizontal or vertical direction.

7. The method of claim 6, wherein the conducting a tilt angle correction comprises:
determining an angle between the recognized edge and the horizontal direction according to a slope of the recognized edge; and
rotating the ID document image by the angle, such that the recognized edge of the ID document image is substantially parallel to the horizontal direction.

8. The method of claim 1, wherein the cutting the information area to obtain at least one character area comprises:
generating a first histogram of the information area in a horizontal direction, wherein the first histogram includes a vertical coordinate of each row of pixel points and an accumulative value of foreground color pixel points in each row of pixel points;
comparing the accumulative value of foreground color pixel points in each row of pixel points with a first predetermined threshold value, and recognizing n rows of character areas, each of the n rows of character areas including m consecutive rows of the foreground color pixel points in the first histogram, wherein an accumulative value of foreground color pixel points in each of the m consecutive rows is greater than the first predetermined threshold value;
generating a second histogram in a vertical direction for the information area, the second histogram including a horizontal coordinate of each column of pixel points and an accumulative value of foreground color pixel points in each column of pixel points;
comparing the accumulative value of foreground color pixel points in each column of pixel points with a second predetermined threshold value, and recognizing i columns of character areas, each of the i columns of character areas including p consecutive columns of the foreground color pixel points in the second histogram, wherein an accumulative value of foreground color pixel points in each of the p consecutive columns is greater than the second predetermined threshold value.

9. An apparatus for area recognition, comprising:
a processor; and
a memory configured to store instructions executable by the processor,
wherein the processor is configured to:
recognize an edge in an identification (ID) document image, the edge being in a predefined direction of the ID document;
recognize at least one information area in the ID document image based on the recognized edge; and
cut the information area to obtain at least one character area.

10. The apparatus of claim 9, wherein the processor is further configured to:
perform Sobel horizontal filtering and binarizing on the ID document image to obtain a processed ID document image; and
conduct a line detection for a predefined area in the processed ID document image to obtain a target line, wherein the target line is recognized as the edge of the ID document image.

11. The device of claim 10, wherein the processor is further configured to:
zoom out the ID document image with a predefined zoom-out scale.

12. The device of claim 10, wherein the processor is further configured to:
conduct an area-connection process to remove areas outside of the ID document in the processed ID document image.

13. The device of claim 10, wherein the processor is further configured to:
recognize the at least one information area based on the recognized edge and a relative location relationship between the recognized edge and the information area.

14. The device of claim 9, wherein the processor is further configured to:
conduct a tilt angle correction to the ID document image to rotate the ID document image so that the recognized edge is substantially parallel to a horizontal or vertical direction.

15. The device of claim 14, wherein the processor is further configured to:
determine an angle between the recognized edge and the horizontal direction according to a slope of the recognized edge; and
rotate the ID document image by the angle, such that the recognized edge of the ID document image is substantially parallel to the horizontal direction.

16. The device of claim 9, wherein the processor is further configured to:
generate a first histogram of the information area in a horizontal direction, wherein the first histogram includes a vertical coordinate of each row of pixel points and an accumulative value of foreground color pixel points in each row of pixel points;
compare the accumulative value of foreground color pixel points in each row of pixel points with a first predetermined threshold value, and recognize n rows of character areas, each of the n rows of character areas including m consecutive rows of the foreground color pixel points in the first histogram, wherein an accumulative value of foreground color pixel points in each of the m consecutive rows is greater than the first predetermined threshold value;
generate a second histogram in a vertical direction for the information area, the second histogram including a horizontal coordinate of each column of pixel points and an accumulative value of foreground color pixel points in each column of pixel points;
compare the accumulative value of foreground color pixel points in each column of pixel points with a second predetermined threshold value, and recognize i columns of character areas, each of the i columns of character areas including p consecutive columns of the foreground color pixel points in the second histogram, wherein an accumulative value of foreground color pixel points in each of the p consecutive columns is greater than the second predetermined threshold value.

17. A non-transitory computer-readable storage medium having instructions stored thereon, the instructions, when executed by a processor of a device, cause the device to:
recognize an edge in an identification (ID) document image, the edge being in a predefined direction of the ID document;
recognize at least one information area in the ID document image based on the recognized edge; and
cut the information area to obtain at least one character area.
